(19) United States
(12) Patent Application Publication
(10) Pub. No.: US 2025/0142682 A1
(43) Pub. Date: May 1, 2025

(54) ELECTRONIC DEVICE INCLUDING SPLIT ELECTRODE STRUCTURES

(71) Applicant: SAMSUNG ELECTRONICS CO., LTD., Suwon-si (KR)

(72) Inventors: Jihoon KIM, Suwon-si (KR); Taedong GOH, Suwon-si (KR); Minsik CHO, Suwon-si (KR); Bohwan CHOI, Suwon-si (KR); Jinsoo CHOI, Suwon-si (KR); Youngho RYU, Suwon-si (KR)

(73) Assignee: SAMSUNG ELECTRONICS CO., LTD., Suwon-si (KR)

(21) Appl. No.: 19/009,420

(22) Filed: Jan. 3, 2025

Related U.S. Application Data
(63) Continuation of application No. PCT/KR2023/006538, filed on May 15, 2023.

(30) Foreign Application Priority Data
Jul. 5, 2022 (KR) 10-2022-0082767

(51) Int. Cl. H05B 6/54; H05B 6/62

(52) U.S. Cl. CPC H05B 6/54; H05B 6/62

(57) ABSTRACT

Provided is an electronic device configured to accommodate at least one container, the electronic device including a conductive plate configured to form an electric field based on a container being accommodated at a designated position of the electronic device, and a conductive member connected to the conductive plate and having an adjustable length, the conductive member being configured to adjust a position of the conductive plate based on the adjustable length, wherein the conductive plate includes a plurality of conductive plates that are spaced apart from each other by a gap formed along a direction parallel to a longitudinal cross-section of the container, and wherein, based on the container being accommodated at the designated position, the plurality of conductive plates are configured to form an electric field in a transverse cross-section direction of the container.

### CROSS-REFERENCE TO RELATED APPLICATIONS

This application is a bypass continuation of International Application No. PCT/KR2023/006538, filed on May 15, 2023, which is based on and claims priority to Korean Patent Application No. 10-2022-0082767, filed on Jul. 5, 2022, in the Korean Intellectual Property Office, the disclosures of which are incorporated by reference herein in their entireties.

### BACKGROUND

### 1. Field

Embodiments of the present disclosure to an electronic device including a split electrode structure for beverage sterilization.

### 2. Description of Related Art

Induction heating or dielectric heating has been used as a sterilization technique for food, including beverages, because it quickly and effectively penetrates energy into an object to heat and sterilize the object. For example, electronic devices such as a microwave oven have been widely used because they are capable of more easily heating an object by radiating energy of microwave wavelengths (e.g., high-frequency waves of 2.4 GHz to 2.5 GHz).

However, some problems may arise from heating an object using such a conventional electronic device. For example, as high-frequency energy radiated from a microwave oven has a short wavelength and thus does not reach deep into an object, the inside and outside of food, including beverages, may not be evenly heated. Moreover, components such as magnetrons should be provided to radiate the high-frequency energy described above, which increases manufacturing costs.

An embodiment of the disclosure is devised to address the above problems, and may provide an electronic device including a split electrode structure which may radiate energy at a lower frequency than a microwave oven and a conventional electronic device, and evenly heat the inside and outside of food including beverages.

### SUMMARY

One or more embodiments provide an electronic device including a split electrode structure for beverage sterilization.

According to an embodiment, there is provided an electronic device configured to accommodate a plurality of containers, the electronic device including a conductive plate configured to form an electric field wherein a container among the plurality of containers is at least partially surrounded by the conductive plate when the container being accommodated at a designated position of the electronic device, and a conductive member connected to the conductive plate and having an adjustable length, the conductive member being configured to adjust a position of the conductive plate based on the adjustable length, wherein the conductive plate includes a plurality of conductive plates that are spaced apart from each other by a gap, and wherein the plurality of conductive plates are configured to form an electric field in a transverse cross-section direction of the container which is accommodated at the designated position.

The electronic device may further include a housing, wherein the housing includes at least one receiving portion including the conductive plate and the conductive member.

The plurality of conductive plates may be spaced apart from each other by a first gap formed along the direction parallel to the longitudinal cross-section of the container and a second gap formed along a direction parallel to the transverse cross-section of the container.

The conductive plate may be configured to be applied by alternating current.

The alternating current may have a frequency range of several MHz to several tens of MHz.

The conductive member may include an elastic material.

Based on the container being inserted into the designated position of the electronic device, the conductive member may be configured to be contracted, and based on the container being accommodated at the designated position, the conductive member may be configured to be relaxed such that the conductive plate is adjacent to the container.

The electronic device may further include a length controller configured to adjust a length of the conductive member.

The length controller may be configured to adjust a resonance point of a load circuit by adjusting the length of the conductive member.

The electronic device may further include at least one processor.

The at least one processor may be configured to apply current to a conductive plate among the plurality of conductive plates at a position corresponding to a remaining amount of a beverage in the container.

The at least one processor may be configured to measure the remaining amount of the beverage in the container based on measuring impedance of the conductive member.

The electronic device may further include an impedance measuring and matching portion.

The conductive plate may be formed in a cylindrical shape.

The electronic device may be one of a refrigerator, a sterilizer, and a dryer.

According to an embodiment, there is provided an electronic device configured to accommodate a plurality of containers, the electronic device including an electrode configured to form an electric field, a coil connected to the electrode and having an adjustable length, the coil being configured to adjust a position of the electrode based on the adjustable length, a housing including a receiving portion in which the electrode and the coil are disposed; and at least one processor, wherein the electrode includes a plurality of electrodes split by a gap, and wherein the plurality of electrodes are configured to sterilize a beverage in a container among the plurality containers by forming an electric field in a transverse cross-section direction of the container which is accommodated at a designated position of the electronic device under control of the at least one processor.

Based on the container being accommodated at the designated position, the plurality of electrodes may be spaced apart from each other by a first gap formed along a direction parallel to the longitudinal cross-section of the container and a second gap formed along a direction parallel to the transverse cross-section of the container.

The electrode may be configured to be applied by alternating current, wherein the alternating current has a frequency range of several MHz to several tens of MHz.

The electronic device may further comprise an impedance measuring and matching portion.

The at least one processor may be configured to measure a remaining amount of a beverage in the container based on the impedance measured through the impedance measuring and matching portion, and adjust the length of the conductive member through the length controller or control the electric field by applying current to at least some of the plurality of electrodes.

### BRIEF DESCRIPTION OF DRAWINGS

Embodiments will be more clearly understood from the following detailed description taken in conjunction with the accompanying drawings in which:

FIG. 1 is a diagram illustrating an electronic device including a split electrode structure according to an embodiment;

FIG. 2 is a block diagram illustrating an electronic device including a split electrode structure according to an embodiment;

FIG. 3A is a diagram illustrating a split electrode structure according to an embodiment;

FIG. 3B is a diagram illustrating a split electrode structure according to an embodiment;

FIG. 4A is a diagram illustrating an electric field formed in the split electrode structure of FIG. 3A;

FIG. 4B is a diagram illustrating an electric field formed in the split electrode structure of FIG. 3B;

FIG. 5A is a diagram illustrating contraction of a conductive member according to an embodiment;

FIG. 5B is a diagram illustrating relaxing of a conductive member according to an embodiment;

FIG. 6 is a diagram illustrating a split electrode structure according to an embodiment;

FIG. 7A is a diagram illustrating a transverse cross-section of the split electrode structure of FIG. 6, taken along an A-A′ direction;

FIG. 7B is a diagram illustrating a transverse cross-section of the split electrode structure of FIG. 6, taken along a B-B′ direction;

FIG. 8 is a diagram illustrating an electronic device including a split electrode structure according to an embodiment;

FIG. 9 is a block diagram illustrating an electronic device including a split electrode structure according to an embodiment;

FIG. 10A is a diagram illustrating a split electrode structure according to an embodiment;

FIG. 10B is a diagram illustrating a split electrode structure according to an embodiment; and

FIG. 11 is a block diagram illustrating an electronic device in a network environment according to an embodiment.

### DETAILED DESCRIPTION

Various embodiments of the disclosure will be described below with reference to the attached drawings.

In the disclosure, like reference numerals denote the same components. The disclosure does not describe all elements of embodiments, and rather avoids a description of common general knowledge in the art or the same parts between embodiments.

In the disclosure, a reference numeral in each step is used for convenience of description, not intended to describe the order of steps, and each step may be performed in a different order from a stated order unless otherwise clearly dictated in the context.

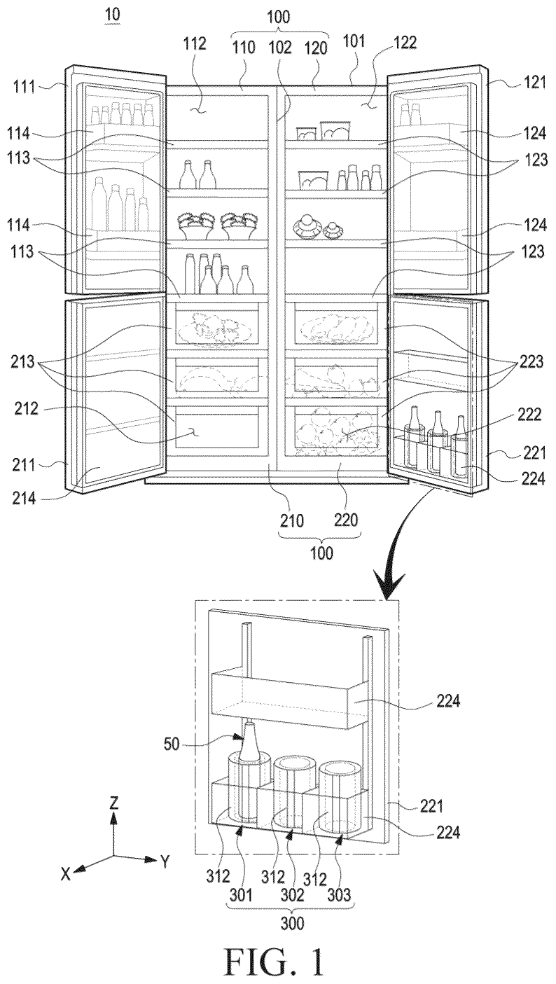

FIG. 1 is a diagram illustrating an electronic device 10 including a split electrode structure according to an embodiment.

In the following detailed description, a vertical width direction (first transverse direction) of the electronic device 10 may be defined as a ‘Y-axis direction’, a horizontal width direction (second transverse direction) thereof as an ‘X-axis direction’, and/or a height direction (length direction/longitudinal direction) as a ‘Z-axis direction’. For example, a ‘longitudinal cross-section of a container 50’ may refer to a cross-section taken along the height direction, that is, the Z-axis direction. Further, for example, a ‘transverse cross-section of the container 50’ may refer to a cross-section taken along the vertical width direction and/or the horizontal width direction, that is, the Y-axis direction and/or the X-axis direction of the container 50. However, it is to be noted that the disclosure is not necessarily limited thereto, and the ‘transverse cross-section of the container 50’ may also refer to a cross-section taken along a direction perpendicular to a Z axis, other than the Y-axis direction or the X-axis direction. In some embodiments, for a direction in which a component is directed, ‘negative/positive (−/+)’ may be mentioned together with the orthogonal coordinate system illustrated in the drawing. For example, referring to FIG. 1, when it is said that the container 50 is disposed on a shelf 224, the container 50 may be defined as being disposed in a ‘+Z-axis direction (or first direction)’ on the shelf 224. When ‘negative/positive (−/+)’ is not described for a direction, it may be interpreted to include both a +direction and a −direction unless otherwise defined. That is, the ‘X-axis direction’ may be interpreted to include both a +X direction and a −X direction, and the ‘Y-axis direction’ may be interpreted to include both a +Y direction and a −Y direction. In describing a direction, ‘directed toward one of the three axes of the orthogonal coordinate system’ may include directed in a direction parallel to the axis. This is based on the orthogonal coordinate system illustrated in the drawing, for simplicity of description, and it is to be noted that the description of these directions or components does not limit various embodiments of the disclosure.

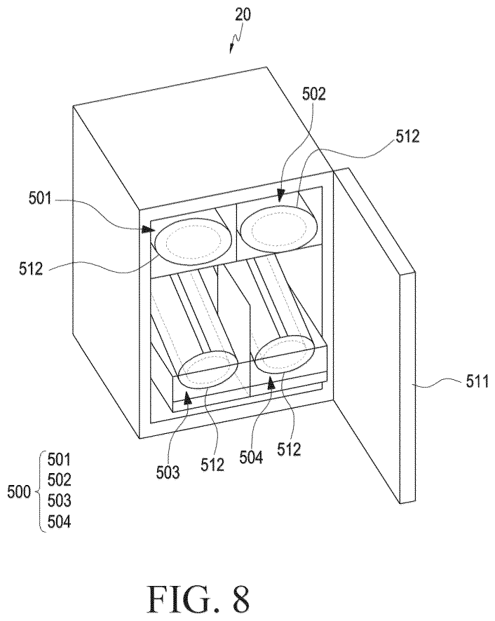

In the embodiment illustrated in FIG. 1, the electronic device 10 may include a refrigerator 100 that maintains a space for accommodating food at a specified low temperature, or a warmer that maintains a space at a specified high temperature. According to an embodiment, the refrigerator 100 may include a freezer maintained at a specified low temperature equal to or lower than the freezing point. In the embodiments of FIGS. 1 to 7, the refrigerator 100 may be described as an example of the electronic device 10. The electronic device 10 includes a housing, and in the following description, a housing of the refrigerator 100 may be described as an example of the housing of the electronic device 10. In the embodiments of FIGS. 8 to 10, a wine refrigerator may be described as an example of an electronic device 20. The configuration of the electronic device 10 of the disclosure will be described below, mainly focusing on an embodiment of the refrigerator 100.

According to an embodiment, the type of the refrigerator 100 may be classified according to the shapes of a storage compartment and a door. The refrigerator 100 may be a top mounted freezer (TMF) type in which a storage compartment is divided into a top compartment and a bottom compartment by a horizontal partition wall such that a freezer is formed at the top and a refrigerator is formed at the bottom, or a bottom mounted freezer (BMF) type in which a refrigerator is formed at the top and a freezer is formed at the bottom. In addition, there may be a side by side (SBS) type refrigerator in which a storage compartment is divided into left and right ones by a vertical partition wall, such that a freezer is formed on one side and a refrigerator is formed on the other side, and a French door refrigerator (FDR) type in which a storage compartment is divided into top and bottom ones by a horizontal partition wall, such that a refrigerator is formed at the top to be opened and closed by a pair of doors and a freezer is formed at the bottom. Other various types of refrigerators may be applied to the disclosure. According to an embodiment, the refrigerator 100 may include, as a housing forming its exterior, a body 101, at least one storage compartment 112, 122, 212, and 222 provided inside the body 101 so that its front is open, and at least one door 111, 121, 211, and 221 pivotably coupled to the body 101 to open and close the open front of the at least one storage compartment 112, 122, 212, and 222.

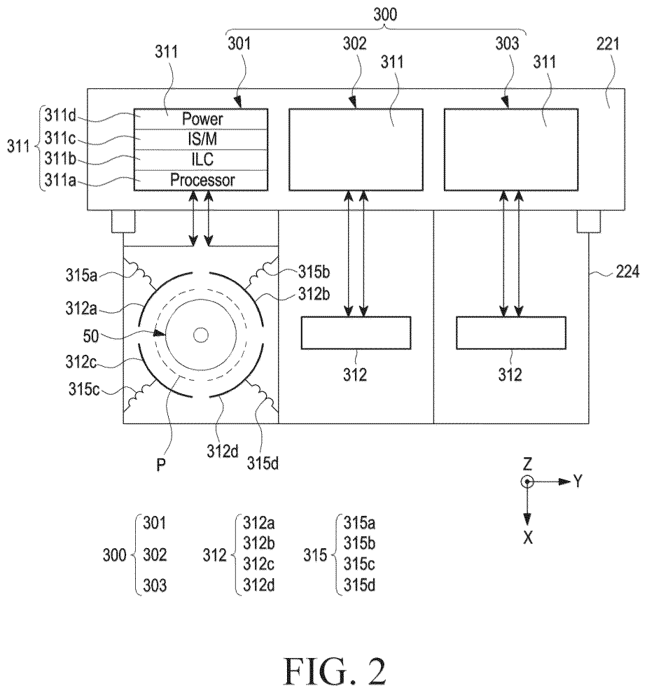

According to an embodiment, the body 101 may include a partition wall 102 that divides the storage compartments 112, 122, 212, and 222 into a plurality of storage compartments. For example, the storage compartments 112, 122, 212, and 222 may be divided into left/right and/or top/bottom storage compartments by the partition wall 102. In FIG. 2, the storage compartments 112, 122, 212, and 222 are shown as being divided into left and right storage compartments by the partition wall 102. However, embodiments are not limited thereto.

According to an embodiment, the storage compartments 112, 122, 212, and 222 and/or the doors 111, 121, 211, and 221 may be provided with a plurality of shelves 113, 114, 123, 124, 214, and 224 and/or storage containers 213 and 223 for placing or receiving food. Additionally or alternatively, regarding division of the storage compartments 112, 122, 212, and 222 by the partition wall 102, the shelves 113, 114 123, 124, 214, and 224 and/or the storage containers 213 and 223 may be divided from each other by further subdividing the internal space of the refrigerator 100.

The refrigerator 100 may be equipped with a cooling system for maintaining the refrigerator 100 in a relatively low temperature state. The cooling system may be provided inside the body 101 of the refrigerator 100 and disposed in a space different from the storage compartments 112, 122, 212, and 222 where food is stored. The cooling system may include various components for circulating cold air, such as a duct, a compressor, a condenser, an expander, an evaporator, other heat exchangers, a blower fan, and a cold air duct. Since the operation of circulating cold air by the cooling system is obvious in the known art, a detailed description thereof will be avoided.

According to an embodiment of the disclosure, the electronic device 10 capable of more evenly heating (sterilizing) an object regardless of the type or size of the object without having an expensive component may be provided by including a split electrode structure 300. In the following embodiments, a beverage requiring sterilization may be taken as an exemplary type of an object, for convenience of description, to which the disclosure is not limited.

The split electrode structure 300 of the disclosure, which relies on induction heating or dielectric heating, may be configured to heat an object using frictional heat generated from rotation or vibration of polar molecules of the object when an electric field is formed around the object. The use of the split electrode structure 300, for example, for a beverage (e.g., wine or milk) requiring sterilization may significantly increase the shelf life of the beverage. The electronic device 10 including the split electrode structure 300 of the disclosure may heat the object using alternating current having a frequency of several MHz to several tens of MHZ, thereby uniformly heating the outside and inside of the object. For example, compared to a microwave oven using energy of an ultra-high frequency of 2.4 GHz to 2.5 GHz under the same heating conditions, the electronic device 10 including the split electrode structure 300 of the disclosure may heat an object using a relatively low frequency (e.g., 27 MHz) and thus transmit energy to a deep position of the object.

The split electrode structure 300 may be provided in a part (e.g., the door 221 and/or the shelf 224 of the door 221) of the electronic device 10 (e.g., the refrigerator 100), as illustrated in FIG. 1. According to an embodiment, the split electrode structure 300 may be modularized for each individual compartment (receiving portion) that divides the shelf 224.

For example, the electronic device 10 may include a plurality of split electrode modules. For example, the electronic device 10 of FIG. 1 may include a first split electrode module 301, a second split electrode module 302, and a third split electrode module 303. In addition, each of the plurality of split electrode modules may include a conductive plate 312 divided into at least two. For example, each of the first split electrode module 301, the second split electrode module 302, and the third split electrode module 303 may include a conductive plate 312 divided into at least two. However, embodiments are not limited to the embodiment illustrated in FIG. 1. For example, the number and positions of the split electrode modules may vary depending on embodiments.

The container 50 that is hollow or contains a beverage may be accommodated in the split electrode structure 300. The type of the beverage in the container 50 may vary and is not limited to a specific embodiment. Although the type of the container 50 is also not limited to a specific embodiment, the container 50 may be described as including a material that allows an electric field to pass therethrough without shielding it, such as, for example, an insulator, paper, glass, or synthetic resin (e.g., plastic) and as containing a predetermined beverage.

FIG. 2 is a block diagram illustrating an electronic device including the split electrode structure 300 according to an embodiment.

According to an embodiment, the electronic device (e.g., the electronic device 10 of FIG. 1) includes the split electrode structure 300, which is modularized and may include a plurality of split electrode modules (e.g., the first split electrode module 301, the second split electrode module 302, and the third split electrode module 303). The plurality of split electrode modules (e.g., the first split electrode module 301, the second split electrode module 302, and the third split electrode module 303) may each include the same components or at least some different components. However, the following description may be based on the assumption that all of the plurality of split electrode modules (e.g., the first split electrode module 301, the second split electrode module 302, and the third split electrode module 303) include the same components. In the following embodiment, when the configuration of a split electrode module is described, the first split electrode module 301 will be taken as an example. The description of the first split electrode module 301 may be adaptively applied to the other split electrode modules (e.g., the second split electrode module 302 and/or the third split electrode module 303).

Referring to FIG. 2, the split electrode module (e.g., the first split electrode module 301) may include at least one component 311, a conductive plate 312, and a conductive member 315.

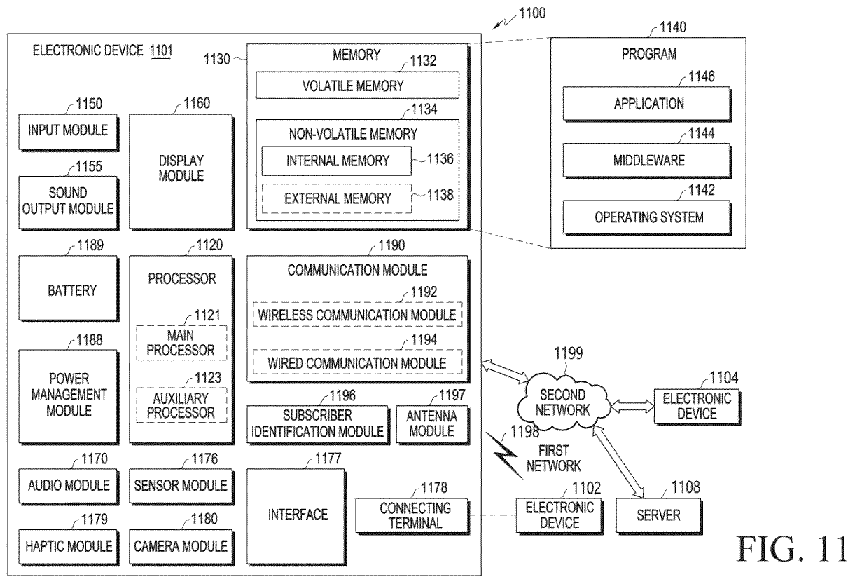

According to an embodiment, the component 311 may include a processor 311a. The processor 311a may control at least one other component (e.g., a hardware or software component) of the electronic device 10 connected to the processor 311a by executing, for example, software (e.g., a program), and perform various data processes or operations. According to an embodiment, as at least part of a data processing or operation, the processor 311a may load a command or data received from another component (e.g., a sensor or a communication interface) to volatile memory, process a command or data stored in the volatile memory, and store the resulting data in non-volatile memory. According to an embodiment, the processor 311a may be a main processor (e.g., a processor 1120 of FIG. 11 described later) for controlling the overall operation of the electronic device 10, or a processor provided separately from the main processor. For example, the processor 311a may be a main processor for controlling various operations of the refrigerator 100 including a cooling cycle, a defrosting cycle, or a cooling-defrosting cycle in which the cooling cycle and the defrosting cycle are performed simultaneously, or may be an individual processor for controlling an operation for forming an electric field when a container is accommodated at the designated position P.

In addition, the split electrode module (e.g., the first split electrode module 301) may include a power source 311d as a component 311, and include a load circuit and a driving circuit connected to the power source 311d. The load circuit may be configured to include at least one resistor, at least one inductor, and at least one capacitor and/or transistor, and the driving circuit may be configured to output power to the load circuit using power provided from the power source 311d. According to some embodiments, a resistor may not be included in the load circuit, as a circuit model of an object to be heated by the split electrode module.

Referring to FIGS. 1 and 2 together, the container 50 may be accommodated at the designated position P in the housing of the electronic device 10. For example, the container 50 may be accommodated at the designated position P of the shelf 224 of the door 221. When the container 50 is accommodated at the designated position P of the housing, the conductive plate 312 may have a form adjacent to and surrounding the container 50. When the container 50 is accommodated at the designated position P of the housing, the container 50 and/or a beverage contained in the container 50 may be affected by an electric field formed by the conductive plate 312 of the split electrode module (e.g., the first split electrode module 301). The conductive plate 312 may be divided into a plurality of conductive plates by at least one gap. In the embodiment of FIG. 2, the conductive plate 312 is shown as being divided into four conductive plates (e.g., 312a, 312b, 312c, and 312d). However, this is merely an example, and the number of conductive plates divided from the conductive plate 312 is not limited. The processor 311a may combine the plurality of conductive plates in at least one pair and apply current so that one side becomes an anode and the other side becomes a cathode. The applied current may be alternating current (AC). According to an embodiment, the applied AC may have a frequency of several MHz to several tens of MHz as described above.

According to an embodiment of the disclosure, the split electrode module (e.g., the first split electrode module 301) may include the conductive member 315 connected to the conductive plate 312 and having a length which is adjusted to enable adjustment of the position of the conductive plate 312. The conductive plate 312 may move away from or toward the designated position P where the container 50 is accommodated, by the conductive member 315. As the conductive plate 312 moves away from or toward the designated position P where the container 50 is accommodated, the magnitude of an electric field formed by the conductive plate 312 may increase or decrease.

When the conductive plate 312 is divided into a plurality of conductive plates, the conductive member 315 may include a plurality of conductive members each connected to one of the plurality of conductive plates. As illustrated in FIG. 2, when the conductive plate 312 is divided into four conductive plates (e.g., 312a, 312b, 312c, and 312d), the conductive member 315 may include four conductive members 315a, 315b, 315c, and 315d each connected to one of the four conductive plates (e.g., 312a, 312b, 312c, and 312d), so that they are individually provided and move independently.

According to an embodiment, at least one capacitor included in the load circuit of the electronic device 10 may be implemented as the conductive plate 312 of the split electrode module (e.g., the first split electrode module 301). For example, at least one capacitor included in the load circuit may be implemented as a pair of conductive plates serving as an anode and a cathode that form an electric field. In addition, at least one inductor included in the load circuit may be implemented as the conductive member 315 of the split electrode module (e.g., the first split electrode module 301). According to an embodiment, described herein may be applied without at least some operations, and at least some operations of an embodiment and at least some operations of another embodiment may be applied mutually organically.

According to an embodiment, the split electrode module (e.g., the first split electrode module 301) may further include a length controller 311b for controlling the length of the conductive member 315. The length controller 311b may be provided, for example, as an inductor length controller (ILC), and may cause a length of the conductive member 315 to increase so that the conductive plate 312 may move closer to the designated position P or cause the length of the conductive member 315 to decrease so that the conductive plate 312 may move away from the designated position. According to an embodiment, a resonance point of the load circuit may be changed through the length controller 311b. The changed resonance point of the load circuit may change an electric field and/or magnetic field formed by the conductive plate 312. According to another embodiment, the length controller 311b may be used to control impedance of the load circuit of the split electrode module (e.g., the first split electrode module 301).

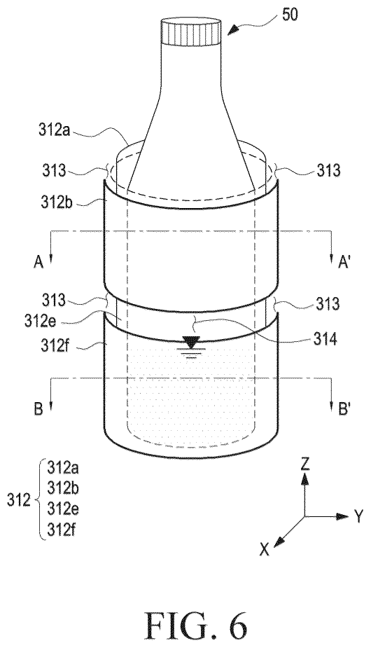

According to an embodiment, the split electrode module (e.g., the first split electrode module 301) may further include an impedance measuring and matching portion 311c for measuring and matching the impedance of the load circuit. According to an embodiment, when the container 50 is accommodated at the designated position P, the processor 311a may measure the remaining amount of a beverage in the container 50 by measuring the impedance. In addition, the processor 311a may apply current only to a conductive plate at a position corresponding to the remaining amount of the beverage in the container among the plurality of conductive plates. This will be described in more detail later with reference to the embodiment of FIG. 6.

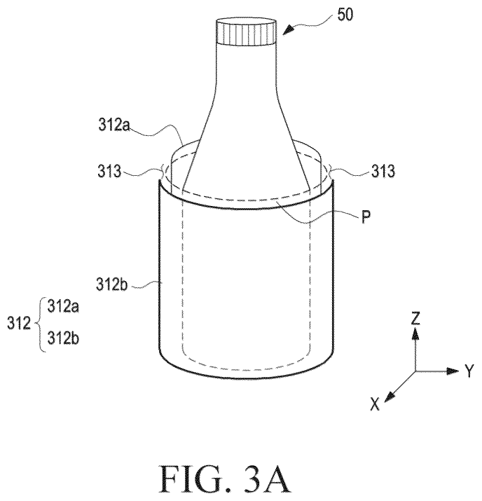

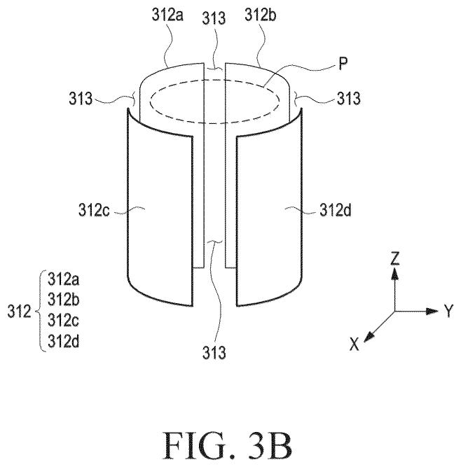

FIG. 3A is a diagram illustrating a split electrode structure according to an embodiment. FIG. 3B is a diagram illustrating the split electrode structure according to an embodiment different from FIG. 3A. FIGS. 3A and 3B may illustrate a split electrode structure included in one (e.g., the first split electrode module 301) of the plurality of split electrode modules of FIGS. 1 and 2, with a conductive member (e.g., the conductive member 315 of FIG. 2) omitted therein.

According to an embodiment, the split electrode structure of the disclosure includes a conductive plate 312 having a cylindrical shape. However, embodiments are not limited thereto and the conductive plate 312 may have various shapes. For example, the conductive plate 312 may have a rectangular parallelepiped or a columnar shape with a pentagonal or more-sided cross-section may be applied.

In the disclosure, when the container 50 is accommodated at the designated position P, the conductive plate 312 may be divided into a plurality of conductive plates by gaps 313 formed along a direction parallel to a longitudinal cross-section of the container 50. For example, the plurality of conductive plates by gaps 313 may be spaced apart from each other by the gaps 313. For example, as illustrated in FIG. 3A, one conductive plate 312 may be divided into two conductive plates 312a and 312b by two gaps 313 formed along the direction parallel to the longitudinal cross-section of the container 50. In another example, as illustrated in FIG. 3B, one conductive plate 312 may be divided into four conductive plates 312a, 312b, 312c, and 312d by four gaps 313 formed along the direction parallel to the longitudinal cross-section of the container 50. In addition, according to an embodiment, the conductive plate 312 may be divided into 2n (n is an integer) conductive plates by 2n gaps formed along the direction parallel to the longitudinal cross-section of the container 50. These divided conductive plates (divided pieces) may have individual potentials, and the direction of an electric field may be determined according to the potentials. The split electrode structure of the disclosure may be divided into a plurality of conductive plates by gaps 313 formed along the direction parallel to the longitudinal cross-section of the container 50, and the divided conductive plates may be combined in pairs to form an electric field along a direction parallel to a transverse cross-section of the container 50.

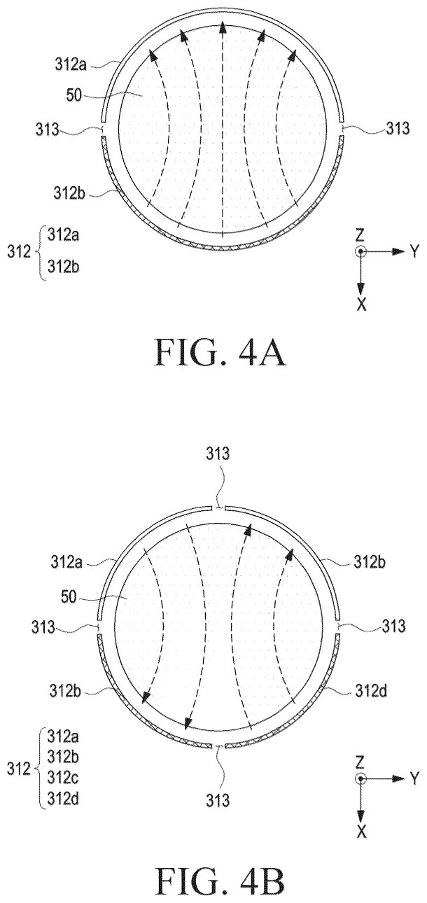

FIG. 4A is a diagram illustrating an electric field formed in the split electrode structure of FIG. 3A.

FIG. 4B is a diagram illustrating an electric field formed in the split electrode structure of FIG. 3B.

Referring to FIG. 4A, when the processor 31a applies AC to the two conductive plates 312a and 312b divided by two gaps 313 formed along the direction parallel to the longitudinal cross-section of the container 50, an electric field directed from the second conductive plate 312b toward the first conductive plate 312a may be formed. When the processor 311a applies AC to the two conductive plates 312a and 312b divided by the two gaps 313 formed along the direction parallel to the longitudinal cross-section of the container 50, an electric field directed from the first conductive plate 312a toward the second conductive plate 312b may also be formed.

Referring to FIG. 4B, when the processor 311a applies AC to the four conductive plates 312a, 312b, 312c, and 312d divided by four gaps 313 formed along the direction parallel to the longitudinal cross-section of the container 50, a first electric field directed from the first conductive plate 312a toward the third conductive plate 312c or from the third conductive plate 312c toward the first conductive plate 312a, and a second electric field directed from the second conductive plate 312b toward the fourth conductive plate 312d or from the fourth conductive plate 312d toward the second conductive plate 312b may be formed. However embodiments are not limited thereto. For example, an embodiment in which an electric field is formed from the first conductive plate 312a toward the second conductive plate 312b or an electric field is formed from the third conductive plate 312c toward the fourth conductive plate 312d may also be applied, and implementation of other various embodiments may also be possible.

Referring to FIGS. 4A and 4B, the electronic device 10 including the split electrode structure of the disclosure may form electric fields directed in various directions toward the container 50, and form a uniform electric field toward the container 50.

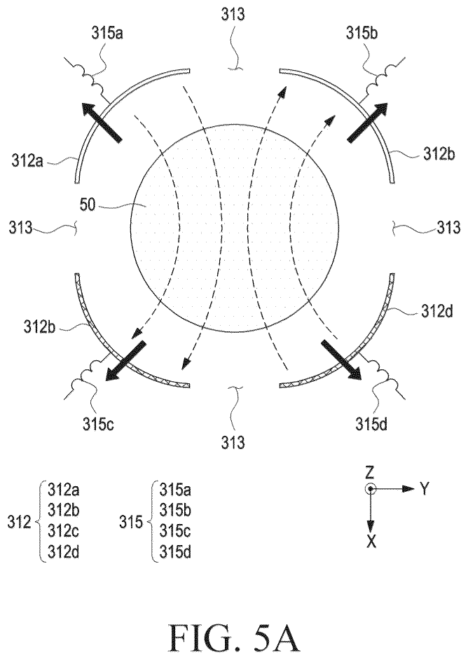

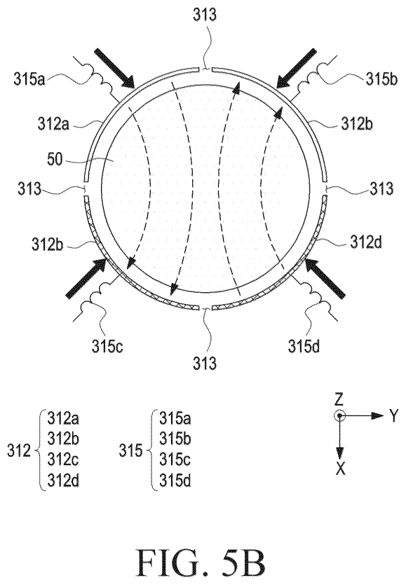

FIG. 5A is a diagram illustrating contraction of a conductive member according to an embodiment. FIG. 5B is a diagram illustrating relaxing of a conductive member according to an embodiment.

According to an embodiment, when the container 50 is inserted to the designated position P, a space which the container 50 is to enter may be secured by contracting the conductive member 315 connected to the conductive plate 312. After the container 50 is inserted to the designated position P, the conductive plate 312 may be brought into close contact with the container 50 by relaxing (or restoring or expanding) the conductive member 315 connected to the conductive plate 312. In addition, as the electronic device 10 of the disclosure is provided with the conductive member 315 including an elastic material, the conductive member 315 may adjust the distance from the container 50 to the conductive plate 312 according to the diameter of the container 50 containing a beverage. For example, the electronic device 10 may change the position of the conductive plate 312 so that not only a container 50 with a relatively small diameter but also a container with a relatively large diameter may be accommodated. The conductive member 315 including the elastic material may be, for example, but not limited to, a coil. In an embodiment in which the conductive member 315 does not include an elastic material, a component including a bearing may correspond to the conductive member 315.

According to an embodiment, the plurality of conductive members 315a, 315b, 315c, and 315d formed to correspond to the plurality of conductive plates 312a, 312b, 312c, and 312d, respectively may be independently controlled to more precisely adjust an electric field formed by the split electrode structure.

As described above, the conductive member 315 may be implemented as an inductor of the load circuit. For example, when a coil is used as the conductive member 315, the conductive member 315 may be used as an inductor for matching the resonance point of the load circuit in relation to the conductive plate 312 implemented as a capacitor.

FIG. 6 is a diagram illustrating a split electrode structure according to an embodiment. Compared to the embodiment (e.g., longitudinal division) of FIG. 3A in which gaps are formed in the direction parallel to the longitudinal cross-section of the container 50, gaps are additionally formed in the direction parallel to the transverse cross-section of the container 50 (hereinafter, “transverse division”) in addition to the embodiment (hereinafter, “longitudinal division”) in which gaps are formed in the direction parallel to the longitudinal cross-section of the container 50, in the embodiment of FIG. 6.

In the electronic device 10 including the split electrode structure, when the container 50 is accommodated at the designated position P, one conductive plate 312 may be divided into a plurality of conductive plates by first gaps 313 formed along the direction parallel to the longitudinal cross-section of the container 50 and a second gap 314 formed along the direction parallel to the transverse cross-section of the container 50. For example, referring to FIG. 6, the conductive plate 312 may be divided into the four conductive plates 312a, 312b, 312e, and 312f by the first gaps 313 formed along the direction parallel to the longitudinal cross-section of the container 50 and the second gap 314 formed along the direction parallel to the transverse cross-section of the container 50. As described above in the embodiments of FIGS. 3A and 3B, the number of divisions is not limited.

According to an embodiment, the electronic device 10 may divide the conductive plate 312 into a plurality of conductive plates by the second gap 314 formed along the direction parallel to the transverse cross-section of the container 50, and perform an operation of applying current only to a conductive plate at a position corresponding to the remaining amount of a beverage in the container 50 according to the remaining amount of the beverage in the container 50. The operations of measuring the remaining amount of the beverage in the container 50 and applying current based on the measurement may be performed through impedance measurement and the matching portion 311c and the processor 311a of FIG. 2, respectively.

For example, when the remaining amount of the beverage in the container 50 is equal to or less than half of the container 50 as illustrated in FIG. 6, the processor 311a may perform an operation of applying current only to the lower conductive plates 312e and 312f among the plurality of conductive plates 312a, 312b, 312e, and 312f. This enables a customized and/or intensive heating or sterilization operation for the remaining amount of the beverage in the container.

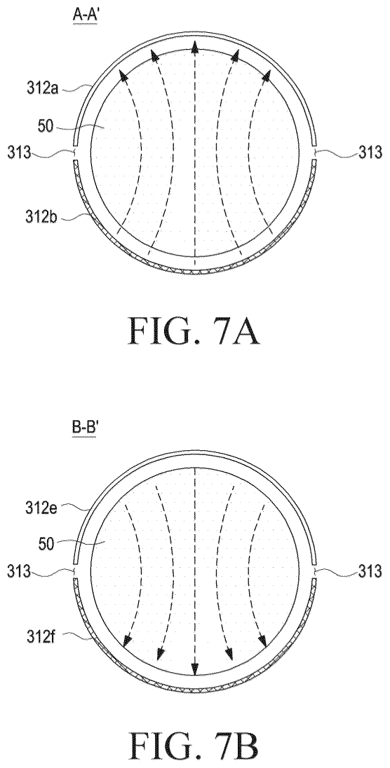

FIG. 7A is a diagram illustrating a transverse cross-section of the split electrode structure of FIG. 6, taken along an A-A′ direction. FIG. 7B is a diagram illustrating a transverse cross-section of the split electrode structure of FIG. 6, taken along a B-B′ direction.

Referring to FIGS. 7A and 7B, the electronic device 10 may also form electric fields in different directions depending on the height of the container 50. The formation of electric fields in different directions in one container 50 may increase heating or sterilization efficiency.

The horizontal division of the conductive plate is not limited to that illustrated in FIGS. 6 to 7B, and the conductive plate may be divided into more pieces along the longitudinal direction and/or the transverse direction. In some embodiments, the conductive plates forming electric fields directed in opposite directions may be divided into more pieces and formed alternately along the longitudinal direction. It has been described above in the foregoing embodiments that the split electrode structure is divided parallel or perpendicular to the Y axis and/or the X axis, by way of example. However, embodiments are not limited thereto. For example, the disclosure may include a split electrode structure divided by gaps formed in a direction which is not parallel to any of the X axis, Y axis, and Z axis.

FIG. 8 is a diagram illustrating an electronic device including a split electrode structure according to an embodiment.

FIG. 8 illustrates a different type of electronic device 20 (e.g., the wine refrigerator (or a wine cellar)) from the refrigerator 100 illustrated in FIG. 1. The electronic device 20 includes a housing, and in the following description, a housing of the wine refrigerator may be taken as an example of the housing of the electronic device 20.

According to an embodiment, the wine refrigerator of FIG. 8 may keep the container 50 at least partially lying down, unlike the refrigerator 100 which keeps the container 50 standing up on the shelf 224.

According to an embodiment, the wine refrigerator may include, as a housing forming its exterior, a body, at least one storage compartment provided inside the body, with its front opened, and at least one door rotatably coupled to the body to open and close the open front of the at least one storage compartment.

According to an embodiment, the body 401 may include a partition wall 402 that divides the storage compartments 411, 412, 413, and 414 into a plurality of storage compartments. For example, the storage compartment may be divided into left/right and/or up/down storage compartments by the partition wall. In FIG. 8, the up/down/left/right storage compartments 411, 412, 413, and 414 are divided from each other by the partition wall, to which the disclosure is not limited.

According to an embodiment, a split electrode structure 500 may be provided in a part (e.g., the storage compartments 411, 412, 413, and 414) of the electronic device 20 (e.g., the wine refrigerator 400), as illustrated in FIG. 8. According to an embodiment, the split electrode structure 500 may be individually modularized for each compartment (e.g., receiving portion) that divides a storage compartment. That is, the electronic device 20 may include a plurality of split electrode modules. For example, the electronic device 20 of FIG. 8 may include a first split electrode module 501, a second split electrode module 502, a third split electrode module 503, and a fourth split electrode module 504. In addition, each of the plurality of split electrode modules may include a conductive plate 512 divided into at least two. For example, each of the first split electrode module 501, the second split electrode module 502, the third split electrode module 503, and the fourth split electrode module 504 may include a conductive plate 512 divided into at least two. However, embodiments are not limited thereto. For example, the number and positions of split electrode modules may vary depending on embodiments. Hereinafter, a redundant description to that of the embodiment of FIG. 1 may be avoided.

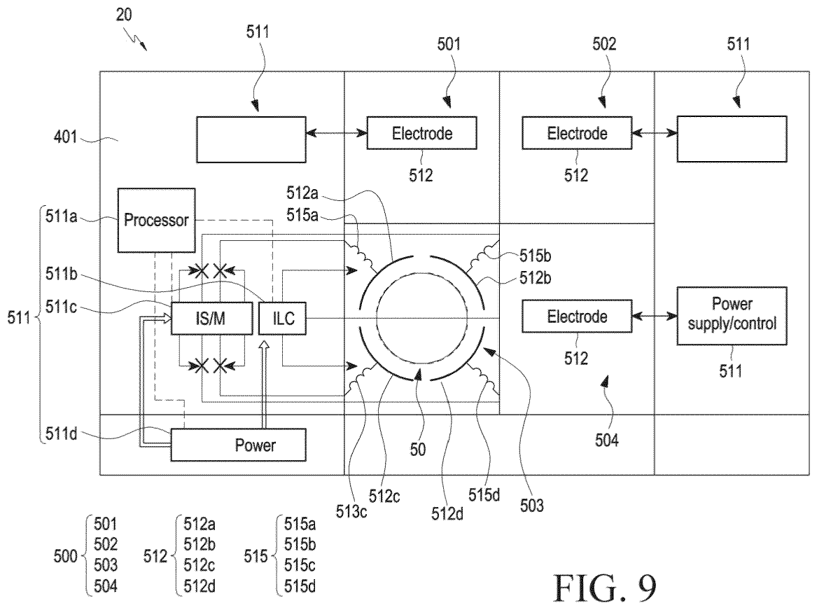

FIG. 9 is a block diagram illustrating the electronic device 20 including a split electrode structure according to an embodiment of the disclosure different from that of FIG. 1.

According to an embodiment, the electronic device (e.g., the electronic device 20 of FIG. 8) may include the split electrode structure 500, which as a modularized split electrode structure 500, may include a plurality of split electrode modules (e.g., the first split electrode module 501, the second split electrode module 502, the third split electrode module 503, and the fourth split electrode module 504). Each of the plurality of split electrode modules (e.g., the first split electrode module 501, the second split electrode module 502, the third split electrode module 503, and the fourth split electrode module 504) may include the same components or at least some different components. However, the following description is based on the assumption that all of the plurality of split electrode modules (e.g., the first split electrode module 501, the second split electrode module 502, the third split electrode module 503, and the fourth split electrode module 504) include the same components. In the following embodiment, the first split electrode module 501 will be described in detail as an example in describing components included in a split electrode module.

Referring to FIG. 9, the split electrode module (e.g., the first split electrode module 501) may include at least one component 511, a conductive plate 512, and a conductive member 515.

According to an embodiment, the component 511 may include a processor 511a. In addition, the split electrode module (e.g., the first split electrode module 501) may include a power source 511d, and a load circuit and a driving circuit connected to the power source 511d. The load circuit may be configured to include at least one resistor, at least one inductor, and at least one capacitor and/or transistor, and the driving circuit may be configured to output power to the load circuit using power provided from the power source 511d. According to an embodiment, the at least one resistor may not be included in the load circuit, as a circuit model of an object to be heated by the split electrode module.

Referring to FIGS. 8 and 9 together, the container 50 may be accommodated at the designated position P in the housing of the electronic device 20. For example, containers 50 may be accommodated at designated positions P of the storage compartments 411, 412, 413, and 414. According to an embodiment, the containers 50 may be accommodated inclined (lying obliquely) with respect to the direction of gravity in the storage compartments 411, 412, 413, and 414. When the container 50 is accommodated at the designated position P of the housing, the conductive plate 512 may have a shape adjacent to and surrounding the container 50. When the container 50 is accommodated at the designated position P of the housing, the container 50 and/or a beverage in the container 50 may be affected by an electric field formed by the conductive plate 512 of the split electrode module (e.g., the first split electrode module 501). While the conductive plate 512 is shown as being divided into a plurality of conductive plates (e.g., 512a, 512b, 512c, and 512d) by at least one gap in the embodiment of FIG. 9, this is only an example, and the number of conductive plates divided from the conductive plate 512 is not limited. The processor 511a may combine the plurality of conductive plates in pairs and apply current to them such that one conductive plate serves as an anode and the other conductive plate serves as a cathode. The applied current may be AC. According to an embodiment, the applied AC may have a frequency of several MHz to several tens of MHz, as described above.

According to an embodiment of the disclosure, the split electrode module (e.g., the first split electrode module 501) may include the conductive member 515 connected to the conductive plate 512 and having a length which is adjusted to enable adjustment of the position of the conductive plate 512. The conductive plate 512 may move away from or toward the designated position P where the container 50 is accommodated, by the conductive member 515.

According to an embodiment, the split electrode module (e.g., the first split electrode module 501) may further include a length controller 511b for adjusting the length of the conductive member 515. The length controller 511b may be provided, for example, as an ILC and cause a length of the conductive member 515 to increase so that the conductive plate 512 may move closer to the designated position P or the length of the conductive member 515 to decrease so that the conductive plate 512 may move away from the designated position. According to an embodiment, the resonance point of the load circuit may be changed by the length controller 511b. An electric field and/or magnetic field formed by the conductive plate 512 may be changed by changing the resonance point of the load circuit. In addition, according to an embodiment, the impedance of the load circuit of the split electrode module (e.g., the first split electrode module 501) may also be adjusted by the length controller 511b. According to an embodiment, the split electrode module (e.g., the first split electrode module 501) may further include an impedance measuring and matching portion 511c for measuring and matching impedance of the load circuit. According to an embodiment, when the container 50 is accommodated at the designated position P, the processor 511a may measure the remaining amount of a beverage in the container 50 by measuring the impedance. Further, the processor 511a may apply current only to a conductive plate at a position corresponding to the remaining amount of the beverage in the container among the plurality of conductive plates. The description of the first split electrode module 501 may be adaptively applied to the other split electrode modules (e.g., the second split electrode module 502, the third split electrode module 503, and/or the fourth split electrode module 504).

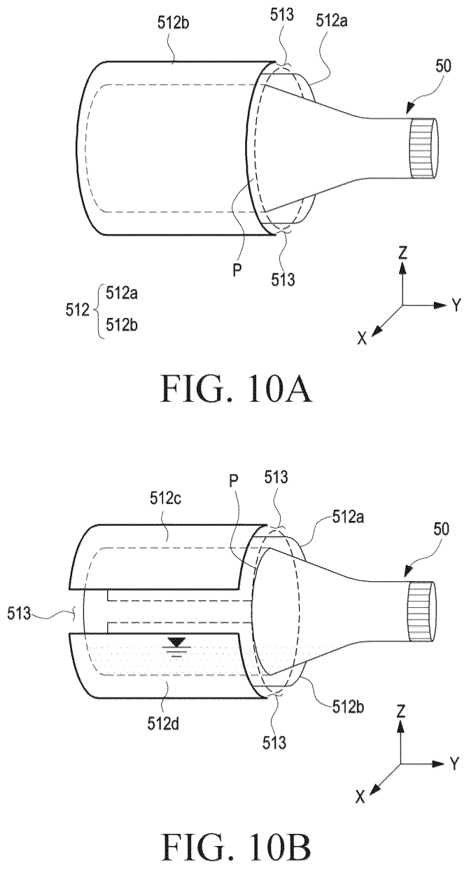

FIG. 10A is a diagram illustrating a split electrode structure according to an embodiment. FIG. 10B is a diagram illustrating a split electrode structure according to an embodiment. FIGS. 10A and 10B may illustrate a split electrode structure included in one (e.g., the first split electrode module 501) of the plurality of split electrode modules of FIGS. 8 and 9, with a conductive member omitted therein.

According to an embodiment, the split electrode structure of the disclosure includes a conductive plate 512 in a cylindrical shape. However, embodiments are not limited thereto. For example, the conductive plate 512 may have a rectangular parallelepiped or a columnar shape having a pentagonal or more-sided cross-section may be applied.

According to an embodiment, the conductive plate 512 may be divided into a plurality of conductive plates by a gap 513 formed along the direction parallel to the longitudinal cross-section of the container 50, when the container 50 is accommodated at the designated position P. For example, as illustrated in FIG. 10A, one conductive plate 512 may be divided into two conductive plates 512a and 512b by two gaps 513 formed along the direction parallel to the longitudinal cross-section of the container 50. In another example, as illustrated in FIG. 10B, one conductive plate 512 may be divided into four conductive plates 512a, 512b, 512c, and 512d by four gaps 513 formed along the direction parallel to the longitudinal cross-section of the container 50. In another embodiment, the conductive plate 512 may be divided into 2n (n is an integer) conductive plates by 2n (n is an integer) gaps formed along the direction parallel to the longitudinal cross-section of the container 50. Each of these divided conductive plates (divided pieces) has individual potential, and the direction of an electric field may be determined according to the potential. The split electrode structure of the disclosure may be divided into a plurality of conductive plates by gaps 513 formed along the direction parallel to the longitudinal cross-section of the container 50, and the divided conductive plates may be combined in pairs to form an electric field along the direction parallel to the transverse cross-section of the container 50.

Referring to FIG. 10B, the electronic device 20 may divide the conductive plate 512 into a plurality of conductive plates by a first gap 514 formed along the direction parallel to the longitudinal cross-section of the container 50, and perform an operation of applying current only to a conductive plate at a position corresponding to the remaining amount of a beverage in the container 50 according to the remaining amount of the beverage in the container 50. Operations of measuring the remaining amount of the beverage in the container 50 and applying current based on the measurement may be performed through impedance measurement and the matching portion 511c and the processor 511a of FIG. 9, respectively. For example, when the remaining amount of the beverage in the container 50 is equal to or less than half of the container 50 as illustrated in FIG. 10B, the processor 511a may perform the operation of applying current only to the lower conductive plates 512b and 512d among the plurality of conductive plates 512a, 512b, 512c, and 512d. As a result, a customized and/or intensive heating or sterilization operation is possible according to the remaining amount of the beverage in the container. In the embodiments illustrated in FIGS. 1 to 7B, since the container 50 is stored standing up on the shelf 224 of the refrigerator 100, a horizontal split electrode structure is employed for customized and/or intensive heating, whereas in the embodiments illustrated in FIGS. 8 to 10B, since the container 50 is stored at least partially lying down, a vertical split electrode structure alone may be sufficient for customized and/or intensive heating.

In the above-described embodiments, the refrigerator 100 and the wine refrigerator 400 have been described as examples of an electronic device. The above-described embodiments of the split electrode structure may be applied to other various types of electronic devices such as a dishwasher, a sterilizer, and a dryer.

According to an embodiment of the disclosure, an electronic device for sterilization may be provided without the need for costly components by using low-frequency energy, compared to a related electronic device.

According to an embodiment of the disclosure, an electric field may be formed by including a plurality of split electrodes, and the positions of the plurality of electrodes may be adjusted. Therefore, an object may be more evenly heated regardless of the type or size of the object.

In addition, various effects that may be directly or indirectly identified through the specification may be provided.

FIG. 11 is a block diagram illustrating an electronic device 1101 in a network environment 1100 according to various embodiments. Referring to FIG. 11, the electronic device 1101 in the network environment 1100 may communicate with an electronic device 1102 via a first network 1198 (e.g., a short-range wireless communication network), or at least one of an electronic device 1104 or a server 1108 via a second network 1199 (e.g., a long-range wireless communication network). According to an embodiment, the electronic device 1101 may communicate with the electronic device 1104 via the server 1108. According to an embodiment, the electronic device 1101 may include a processor 1120, memory 1130, an input module 1150, a sound output module 1155, a display module 1160, an audio module 1170, a sensor module 1176, an interface 1177, a connecting terminal 1178, a haptic module 1179, a camera module 1180, a power management module 1188, a battery 1189, a communication module 1190, a subscriber identification module (SIM) 1196, or an antenna module 1197. In some embodiments, at least one of the components (e.g., the connecting terminal 1178) may be omitted from the electronic device 1101, or one or more other components may be added in the electronic device 1101. In some embodiments, some of the components (e.g., the sensor module 1176, the camera module 1180, or the antenna module 1197) may be implemented as a single component (e.g., the display module 1160).

The processor 1120 may execute, for example, software (e.g., a program 1140) to control at least one other component (e.g., a hardware or software component) of the electronic device 1101 coupled with the processor 1120, and may perform various data processing or computation. According to one embodiment, as at least part of the data processing or computation, the processor 1120 may store a command or data received from another component (e.g., the sensor module 1176 or the communication module 1190) in volatile memory 1132, process the command or the data stored in the volatile memory 1132, and store resulting data in non-volatile memory 1134. According to an embodiment, the processor 1120 may include a main processor 1121 (e.g., a central processing unit (CPU) or an application processor (AP)), or an auxiliary processor 1123 (e.g., a graphics processing unit (GPU), a neural processing unit (NPU), an image signal processor (ISP), a sensor hub processor, or a communication processor (CP)) that is operable independently from, or in conjunction with, the main processor 1121. For example, when the electronic device 1101 includes the main processor 1121 and the auxiliary processor 1123, the auxiliary processor 1123 may be adapted to consume less power than the main processor 1121, or to be specific to a specified function. The auxiliary processor 1123 may be implemented as separate from, or as part of the main processor 1121.

The auxiliary processor 1123 may control at least some of functions or states related to at least one component (e.g., the display module 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). According to an embodiment, the auxiliary processor 1123 (e.g., an image signal processor or a communication processor) may be implemented as part of another component (e.g., the camera module 1180 or the communication module 1190) functionally related to the auxiliary processor 1123. According to an embodiment, the auxiliary processor 1123 (e.g., the neural processing unit) may include a hardware structure specified for artificial intelligence model processing. An artificial intelligence model may be generated by machine learning. Such learning may be performed, e.g., by the electronic device 1101 where the artificial intelligence is performed or via a separate server (e.g., the server 1108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134.

The program 1140 may be stored in the memory 1130 as software, and may include, for example, an operating system (OS) 1142, middleware 1144, or an application 1146.

The input module 1150 may receive a command or data to be used by another component (e.g., the processor 1120) of the electronic device 1101, from the outside (e.g., a user) of the electronic device 1101. The input module 1150 may include, for example, a microphone, a mouse, a keyboard, a key (e.g., a button), or a digital pen (e.g., a stylus pen).

The sound output module 1155 may output sound signals to the outside of the electronic device 1101. The sound output module 1155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1160 may visually provide information to the outside (e.g., a user) of the electronic device 1101. The display module 1160 may include, for example, a display, a hologram device, or a projector and control circuitry to control a corresponding one of the display, hologram device, and projector. According to an embodiment, the display module 1160 may include a touch sensor adapted to detect a touch, or a pressure sensor adapted to measure the intensity of force incurred by the touch.

The audio module 1170 may convert a sound into an electrical signal and vice versa. According to an embodiment, the audio module 1170 may obtain the sound via the input module 1150, or output the sound via the sound output module 1155 or a headphone of an external electronic device (e.g., an electronic device 1102) directly (e.g., wiredly) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. According to an embodiment, the sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device (e.g., the electronic device 1102) directly (e.g., wiredly) or wirelessly. According to an embodiment, the interface 1177 may include, for example, a high definition multimedia interface (HDMI), a universal serial bus (USB) interface, a secure digital (SD) card interface, or an audio interface.

A connecting terminal 1178 may include a connector via which the electronic device 1101 may be physically connected with the external electronic device (e.g., the electronic device 1102). According to an embodiment, the connecting terminal 1178 may include, for example, a HDMI connector, a USB connector, a SD card connector, or an audio connector (e.g., a headphone connector).

The haptic module 1179 may convert an electrical signal into a mechanical stimulus (e.g., a vibration or a movement) or electrical stimulus which may be recognized by a user via his tactile sensation or kinesthetic sensation. According to an embodiment, the haptic module 1179 may include, for example, a motor, a piezoelectric element, or an electric stimulator.

The camera module 1180 may capture a still image or moving images. According to an embodiment, the camera module 1180 may include one or more lenses, image sensors, image signal processors, or flashes.

The power management module 1188 may manage power supplied to the electronic device 1101. According to one embodiment, the power management module 1188 may be implemented as at least part of, for example, a power management integrated circuit (PMIC).

The battery 1189 may supply power to at least one component of the electronic device 1101. According to an embodiment, the battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more communication processors that are operable independently from the processor 1120 (e.g., the application processor (AP)) and supports a direct (e.g., wired) communication or a wireless communication. According to an embodiment, the communication module 1190 may include a wireless communication module 1192 (e.g., a cellular communication module, a short-range wireless communication module, or a global navigation satellite system (GNSS) communication module) or a wired communication module 1194 (e.g., a local area network

(LAN) communication module or a power line communication (PLC) module). A corresponding one of these communication modules may communicate with the external electronic device via the first network 1198 (e.g., a short-range communication network, such as Bluetooth™, wireless-fidelity (Wi-Fi) direct, or infrared data association (IrDA)) or the second network 1199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The wireless communication module 1192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1192 may support a high-frequency band (e.g., the mmWave band) to achieve, e.g., a high data transmission rate. The wireless communication module 1192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1192 may support various requirements specified in the electronic device 1101, an external electronic device (e.g., the electronic device 1104), or a network system (e.g., the second network 1199). According to an embodiment, the wireless communication module 1192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1197 may transmit or receive a signal or power to or from the outside (e.g., the external electronic device) of the electronic device 1101. According to an embodiment, the antenna module 1197 may include an antenna including a radiating element composed of a conductive material or a conductive pattern formed in or on a substrate (e.g., a printed circuit board (PCB)). According to an embodiment, the antenna module 1197 may include a plurality of antennas (e.g., array antennas). In such a case, at least one antenna appropriate for a communication scheme used in the communication network, such as the first network 1198 or the second network 1199, may be selected, for example, by the communication module 1190 (e.g., the wireless communication module 1192) from the plurality of antennas. The signal or the power may then be transmitted or received between the communication module 1190 and the external electronic device via the selected at least one antenna. According to an embodiment, another component (e.g., a radio frequency integrated circuit (RFIC)) other than the radiating element may be additionally formed as part of the antenna module 1197.

According to various embodiments, the antenna module 1197 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1101 and the external electronic device 1104 via the server 1108 coupled with the second network 1199. Each of the electronic devices 1102 or 1104 may be a device of a same type as, or a different type, from the electronic device 1101. According to an embodiment, all or some of operations to be executed at the electronic device 1101 may be executed at one or more of the external electronic devices 1102, 1104, or 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1101. The electronic device 1101 may provide the outcome, with or without further processing of the outcome, as at least part of a reply to the request. To that end, a cloud computing, distributed computing, mobile edge computing (MEC), or client-server computing technology may be used, for example. The electronic device 1101 may provide ultra low-latency services using, e.g., distributed computing or mobile edge computing. In another embodiment, the external electronic device 1104 may include an internet-of-things (IoT) device. The server 1108 may be an intelligent server using machine learning and/or a neural network. According to an embodiment, the external electronic device 1104 or the server 1108 may be included in the second network 1199. The electronic device 1101 may be applied to intelligent services (e.g., smart home, smart city, smart car, or healthcare) based on 5G communication technology or IoT-related technology.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with an embodiment of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

A One or more embodiments as set forth herein may be implemented as software (e.g., the program 1140) including one or more instructions that are stored in a storage medium (e.g., internal memory 1136 or external memory 1138) that is readable by a machine (e.g., the electronic device 1101). For example, a processor (e.g., the processor 1120) of the machine (e.g., the electronic device 1101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store, or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

According to an embodiment of the disclosure, an electronic device capable of accommodating at least one container is provided. The electronic device (e.g., the electronic device 10 of FIG. 1; the electronic device 20 of FIG. 8) may include a conductive plate (e.g., the conductive plate 312 of FIG. 2; the conductive plate 512 of FIG. 9) configured to form an electric field, when a container is accommodated at a designated position, and a conductive member (e.g., the conductive member 315 of FIG. 2; the conductive member 315 of FIG. 9) connected to the conductive plate and having an adjustable length to enable adjustment of a position of the conductive plate. The conductive plate may be split into a plurality of conductive plates by a gap formed along a direction parallel to a longitudinal cross-section of the container, and, when the container is accommodated at the designated position, the plurality of conductive plates are configured to form an electric field in a transverse cross-section direction of the container.

According to an embodiment, the electronic device may include a housing, and the housing may include at least one receiving portion in which the conductive plate and the conductive member are formed.

According to an embodiment, when the container is accommodated at the designated position, the conductive plate may be divided into a plurality of conductive plates by a first gap formed along the direction parallel to the longitudinal cross-section of the container and a second gap formed along a direction parallel to a transverse cross-section of the container.

According to an embodiment, AC may be applied to the conductive plate.

According to an embodiment, the AC may have a frequency range of several MHz to several tens of MHz.

According to an embodiment, the conductive member may include an elastic material.

According to an embodiment, when the container is inserted, the conductive member may be configured to be contracted. When the container is accommodated at the designated position, the conductive member may be relaxed such that the conductive plate surrounds the container.

According to an embodiment, the electronic device may further include a length controller (e.g., the length controller 311b of FIG. 2; the length controller 511b of FIG. 9) for adjusting the length of the conductive member.

According to an embodiment, the length controller may change a resonance point of a load circuit by adjusting the length of the conductive member.

According to an embodiment, the electronic device may further include a processor (e.g., the processor 311a of FIG. 2; the processor 511a of FIG. 9).

According to an embodiment, the processor may apply current only to a conductive plate at a position corresponding to a remaining amount of a beverage in the container among the plurality of conductive plates.

According to an embodiment, when the container is accommodated at the designated position, the processor may measure the remaining amount of the beverage in the container by measuring impedance.

According to an embodiment, the electronic device may further include an impedance measuring and matching portion (e.g., the impedance measuring and matching portion 311c of FIG. 2; the impedance measuring and matching portion 511c of FIG. 9).

According to an embodiment, the conductive plate may be formed in a cylindrical shape.

According to an embodiment, a refrigerator, a sterilizer, and a dryer may be included as the electronic device capable of accommodating at least one container.

According to an embodiment of the disclosure, an electronic device is provided. The electronic device (e.g., the electronic device 10 of FIG. 1; the electronic device 20 of FIG. 8) may include an electrode (e.g., the conductive plate 312 of FIG. 2; the conductive plate 512 of FIG. 9) capable of forming an electric field, a coil (e.g., the conductive member 315 of FIG. 2; the conductive member 515 of FIG. 9) connected to the electrode and having an adjustable length to enable adjustment of a position of the electrode, a housing including a receiving portion in which the electrode and the coil are disposed, and a processor. The electrode may include a plurality of electrodes divided by a gap formed along a direction parallel to a longitudinal cross-section of a container. When the container is accommodated at the designated position of the receiving portion the plurality of conductive electrodes may be configured to sterilize a beverage in the container by forming an electric field in a transverse cross-section direction of the container under control of the processor.

According to an embodiment, the processor may measure a remaining amount of a beverage in the container based on the impedance measured through the impedance measuring and matching portion, and adjust the length of the conductive member through the length controller or control the electric field by selecting at least some of the electrodes and applying current to them.

While embodiments have been described with reference to the figures, it will be understood by those of ordinary skill in the art that various changes in form and details may be made therein without departing from the spirit and scope as defined by the following claims and their equivalents.

What is claimed is:

1. An electronic device configured to accommodate a plurality of containers, the electronic device comprising:
a conductive plate configured to form an electric field, wherein a container among the plurality of containers is at least partially surrounded by the conductive plate when the container is accommodated at a designated position of the electronic device; and
a conductive member connected to the conductive plate and having an adjustable length, the conductive member being configured to adjust a position of the conductive plate based on the adjustable length,
wherein the conductive plate comprises a plurality of conductive plates that are spaced apart from each other by a gap, and
wherein the plurality of conductive plates are configured to form an electric field in a transverse cross-section direction of the container which is accommodated at the designated position.

2. The electronic device of claim 1, further comprising a housing,
wherein the housing comprises at least one receiving portion comprising the conductive plate and the conductive member.

3. The electronic device of claim 1, wherein, the plurality of conductive plates are spaced apart from each other by a first gap formed along a direction parallel to a longitudinal cross-section of the container and a second gap formed along a direction parallel to the transverse cross-section of the container.

4. The electronic device of claim 1, wherein the conductive plate is configured to be applied by alternating current.

5. The electronic device of claim 4, wherein the alternating current has a frequency range of several MHz to several tens of MHz.

6. The electronic device of claim 1, wherein the conductive member includes an elastic material.

7. The electronic device of claim 6, wherein the conductive member is configured to be contracted based on the container being inserted into the designated position of the electronic device, and
wherein the conductive member is configured to be relaxed such that the conductive plate is adjacent to the container based on the container being accommodated at the designated position.

8. The electronic device of claim 1, further comprising a length controller configured to adjust a length of the conductive member.

9. The electronic device of claim 8, wherein the length controller is configured to adjust a resonance point of a load circuit by adjusting the length of the conductive member.

10. The electronic device of claim 1, further comprising at least one processor.

11. The electronic device of claim 10, wherein the at least one processor is configured to apply current to a conductive plate among the plurality of conductive plates at a position corresponding to a remaining amount of a beverage in the container.

12. The electronic device of claim 11, wherein the at least one processor is configured to measure the remaining amount of the beverage in the container based on measuring impedance of the conductive member.

13. The electronic device of claim 12, further comprising an impedance measuring and matching portion.

14. The electronic device of claim 1, wherein the conductive plate is formed in a cylindrical shape.

15. The electronic device of claim 1, wherein the electronic device is one of a refrigerator, a sterilizer, and a dryer.

16. An electronic device configured to accommodate a plurality of containers, the electronic device comprising:
an electrode configured to form an electric field;
a coil connected to the electrode and having an adjustable length, the coil being configured to adjust a position of the electrode based on the adjustable length;
a housing including a receiving portion in which the electrode and the coil are disposed; and
at least one processor,
wherein the electrode includes a plurality of electrodes split by a gap, and
wherein the plurality of electrodes are configured to sterilize a beverage in a container among the plurality of containers by forming an electric field in a transverse cross-section direction of the container which is accommodated at a designated position of the electronic device under control of the at least one processor.

17. The electronic device of claim 16, wherein, based on the container being accommodated at the designated position, the plurality of electrodes are spaced apart from each other by a first gap formed along a direction parallel to the longitudinal cross-section of the container and a second gap formed along a direction parallel to the transverse cross-section of the container.

18. The electronic device of claim 16, wherein the electrode is configured to be applied by alternating current, wherein the alternating current has a frequency range of several MHz to several tens of MHz.

19. The electronic device of claim 16, further comprising an impedance measuring and matching portion.

20. The electronic device of claim 16, wherein the at least one processor is configured to measure a remaining amount of a beverage in the container based on the impedance measured through the impedance measuring and matching portion, and adjust the length of the conductive member through the length controller or control the electric field by applying current to at least some of the plurality of electrodes.
